(19) United States
(12) Patent Application Publication
(10) Pub. No.: US 2004/0200972 A1
(43) Pub. Date: Oct. 14, 2004

(54) Digital x-ray image detector

(76) Inventors: Sang-Hee Nam, Busan (KR); Jae-Hyung Kim, Busan (KR); Chi-Woong Mun, Busan (KR); Hyung-Won Lee, Ginhae-si (KR); Sang-Ho Ahn, Ginhae-si (KR); Heung-Kook Choi, Gimhae-shi (KR); Chung-Gi Eun, Busan (KR)

Correspondence Address: BIRCH STEWART KOLASCH & BIRCH, PO BOX 747, FALLS CHURCH, VA, 22040-0747, US

(21) Appl. No.: 10/486,557

(22) PCT Filed: Dec. 18, 2002
(86) PCT No.: PCT/KR02/02391

(30) Foreign Application Priority Data
Mar. 23, 2002 (KR) 2002-15917

(51) Int. Cl. G01T 1/24

(52) U.S. Cl. 250/370.11; 250/370.09

(57) ABSTRACT

Provided is an X-ray image detector in which an organic conductive polymer layer which generates electron-hole pairs in reaction to a radioactive ray is employed as an X-ray receptor. In the X-ray image detector, organic conductive polymer substituting a-Se that is an existing photoconductive substance is used and a fluorescent layer diverging light of a visible ray area that is a polymer absorption wavelength band is combined, to detect an electric signal of a polymer having a photoconductive characteristic.

### BACKGROUND OF THE INVENTION

1. Field of the Invention

The present invention relates to a digital X-ray image detector, and more particularly, to a digital X-ray image detector in which an organic conductive polymer layer which generates electron-hole pairs in reaction to a radioactive ray is employed as an X-ray receptor.

The organic conductive polymer layer used as an X-ray image detector is polymer based consisting of a polyparaphenylenevynilene derivative, a polytiophene derivative, a polyparaphenylene derivative, a polyethylene derivative, a polyacetyline derivative, and a polyfluorene derivative such as polyvynilcarbazole.

In particular, in the X-ray image detector, tungsten acid calcium or rare-earth based fluorescent substance generating light in reaction to a radioactive ray and CsI:Na, CsI:Tl or ZnS:Ag,Cl ZnS:Cu,Al Y2O2S:Eu ZnS:Ag,Cl+CoO,Al2O3 Y2O2S:Eu+Fe2O3 Y2O3:Eu ZnS:Ag,Al Zn2SiO5:Mn Y2O2S:Tb materials are disposed on a second electrode layer as a fluorescent layer.

2. Description of the Related Art

In general, a digital X-ray image detector converts image information of an radioactive ray to an electric signal and detects the electric signal in a radioactive ray detecting apparatus for detecting a radioactive ray penetrating a human body and obtaining image information.

In the conventional technology method, an X-ray image detector uses inorganic material, such as a-Se, PbI2, HgI2, CdZnTe, and TlBr, as an X-ray receptor. The X-ray image detector has a structure in which a first electrode is formed on a substrate which is a physical support, selenium which is an inorganic X-ray receptor is formed on the first electrode, and a second electrode is formed on the X-ray receptor.

The type of a generally used X-ray image detector is classified into a direct method and an indirect method according to the conversion method of an electric signal. In the direct method which is a method to develop a digital radioactive ray detection apparatus by increasing the amount of generation of an electric signal by a small amount of a radioactive ray, to increase the amount of absorption of an incident radioactive ray, a photoconductive layer which is an X-ray receptor is formed to have a thickness of several hundreds μm or more. However, since a high electric field of several kV DC should be formed for a voltage applied to detect the amount of generation of an electric signal generated in the photoconductive layer, there are problems such as destruction of insulation of a photoconductive body and malfunction of an IC chip for readout due to a high voltage.

In detail, to detect the electric signal generated in the inorganic X-ray receptor layer according to the conventional technology method, a high voltage of 10 V/μm is typically applied. Assuming that the thickness of the X-ray receptor is several hundreds μm, a high voltage of several kV DC should be applied. Thus, electric field concentration occurs in a portion where a defect is present in the receptor or the thickness is small, so that a pixel of a circuit end may be damaged or a panel of the detector may be damaged. Also, by applying a high voltage, the life span of the panel of the detector is shortened.

Furthermore, since the conventional X-ray receptors such as selenium are inorganic, deposition thereof is difficult, the X-ray receptors is hardened after deposition, loosing flexibility, and a large area X-ray image detector is difficult to manufacture.

That is, the inorganic photoconductive material used as an X-ray receptor in a digital radioactive ray detection apparatus which is generally used should be formed in a thermal deposition process in a vacuous state or in a crystal growing method. However, although the uniformity of a thickness of the X-ray receptor of a radioactive ray detection apparatus is directly related to the quality of an image and the thickness of the X-ray receptor should be uniform to endure a high voltage applied to form an electric field, it is difficult in the thermal vacuum deposition method to manufacture the X-ray receptor having a uniform thickness.

### SUMMARY OF THE INVENTION

To solve the above and/or other problems, the present invention provides a digital X-ray image detector which uses organic conductive polymer, which exhibits a superior photosensitivity, has a wide dynamic range, enables a large area coating, and is innocuous to a human body, as an X-ray receptor in the development of a digital radioactive ray detection apparatus of a passive matrix panel base and an active matrix TFT panel base.

Also, the present invention provides an X-ray image detector which improves a radioactive ray detection feature of the organic conductive polymer layer by combining a fluorescent layer generating a visible ray by an incident radioactive ray according to the characteristic of the organic conductive polymer of high absorption efficiency in a wavelength band of a visible ray area and making photocurrent flow by absorbed light.

Also, the present invention provides an X-ray image detector using a low application power characteristic of the organic conductive polymer.

Also, the present invention provides an X-ray image detector which prevents destruction of insulation of the X-ray receptor layer and damage of a TFT device due to a high voltage.

According to an aspect of the present invention, an X-ray image detector comprising: an insulation substrate which is a physical support body; a first electrode layer which is an electron collecting electrode formed on an upper surface of the substrate; an organic conductive polymer layer formed on the upper surface of the first electrode layer and generating electron-hole pairs by a radioactive ray or a visible ray; a second electrode layer formed on an upper surface of the organic conductive polymer layer; a fluorescent layer disposed on an upper surface of the second electrode layer or a lower surface of the substrate; and a readout apparatus connected to the first electrode layer on the substrate and detecting an electric image signal generated by the radioactive ray in the organic conductive polymer layer.

The organic conductive polymer layer is polymer based consisting of a polyparaphenylenevynilene derivative, a polytiophene derivative, a polyparaphenylene derivative, a polyethylene derivative, a polyacetyline derivative, and a polyfluorene derivative such as polyvynilcarbazole.

To improve yield in detecting electron-hole pairs generated by absorbing photons generated from the fluorescent layer by an incident radioactive ray, the organic conductive polymer layer comprises: an electron acceptor layer formed in contact with an electrode to which + pole is applied and made of C60, CN-PPV, and perylene which are materials exhibiting electron effinity; and a hole acceptor layer adjacent to an electrode to which − pole is applied and drawing holes, wherein the electron acceptor layer and the hole acceptor layer are formed in the upper and lower portions of the organic conductive polymer layer, respectively.

The fluorescent layer generates light of a visible ray area wavelength in reaction of an radioactive ray and made of CsI:Na, CsI:Tl or ZnS:Ag,Cl ZnS:Cu,Al Y2O2S:Eu ZnS:Ag,Cl+CoO,Al2O3 Y2O2S:Eu+Fe2O3 Y2O3:Eu ZnS:Ag,Al Zn2SiO5:Mn Y2O2S:Tb.

The first electrode is made of ITO which provides electrons well, to which a negative electrode is applied.

The second electrode is made of metal from a group consisting of Al, Ca, Mg, Au, Ba, and In which provide holes well and having low work functions, to which a positive electrode is applied.

The readout apparatus is a TFT panel or a passive matrix panel.

### BRIEF DESCRIPTION OF THE DRAWINGS

The above and other features and advantages of the present invention will become more apparent by describing in detail preferred embodiments thereof with reference to the attached drawings in which:

FIG. 1 is a sectional view illustrating a digital X-ray image detector according to the present invention in which a TFT panel is used a readout apparatus;

FIG. 2 is a view illustrating a structure of a digital X-ray image detector according to the present invention in which a passive matrix panel is used a readout apparatus;

FIG. 3 is a view illustrating a structure in which fluorescent substance is formed on an upper surface of a secondary electrode of the digital X-ray image detector according to the present invention;

FIG. 4 is a view illustrating a structure in which fluorescent substance is formed on a lower surface of a substrate of the digital X-ray image detector according to the present invention;

FIG. 5 is a view illustrating a structure of deposition of an organic conductive polymer layer of the digital X-ray image detector according to the present invention;

FIG. 6 is a graph showing photosensitivity of MEH-PPV:C60 per wavelength band, which is an organic conductive polymer of the digital X-ray image detector according to the present invention; and

FIG. 7 is a spectrum of illumination of ZnS:Ag per wavelength which is a representative fluorescent layer material.

### DETAILED DESCRIPTION OF THE INVENTION

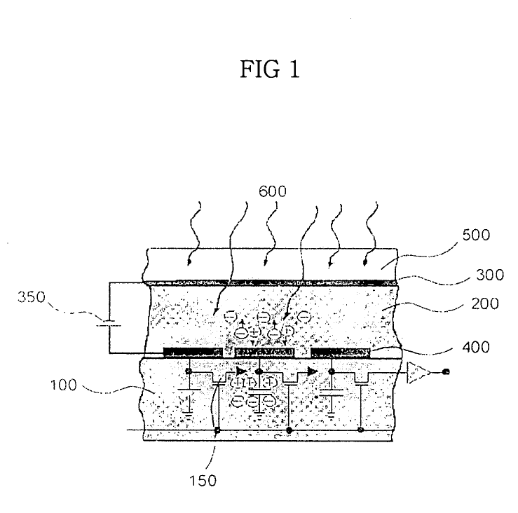

FIG. 1 is a view showing the section of an X-ray image detector formed of an active matrix TFT panel 150 as an example of a layered structure of an X-ray image detector according to the present invention.

As shown in FIG. 1, the present invention includes an insulation substrate 100, a first electrode layer 400, an organic conductive polymer layer 200, a second electrode layer 300, and a fluorescent layer 500.

The insulation substrate 100, on which a panel is formed by the active matrix TFT panel 150 cell arrangement, is a physical support of the first electrode layer 400, the organic conductive polymer layer 200, and the second electrode layer 300.

Since the TFT panel structure, function, and material of the insulation substrate 100 are almost the same as a conventional TFT panel substrate of an X-ray image detector using an inorganic X-ray receptor, a detailed description thereof will be omitted.

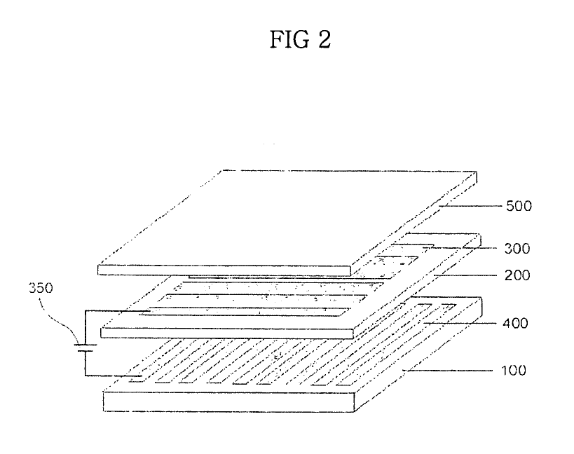

FIG. 2 is a view showing the an X-ray image detector formed on a passive matrix panel base which is another readout apparatus.

As shown in FIG. 2, the passive matrix panel has a sandwich structure in which the organic conductive polymer layer 200 is interposed between the first electrode layer 400 and the second electrode layer 300 and the electrodes in strips are disposed crossing each other.

When power is applied to the first electrode layer 400 and the second electrode layer 300, a cross point is a unit pixel for detecting an X-ray image and an electric signal of an image is generated according to the strength of the X-ray.

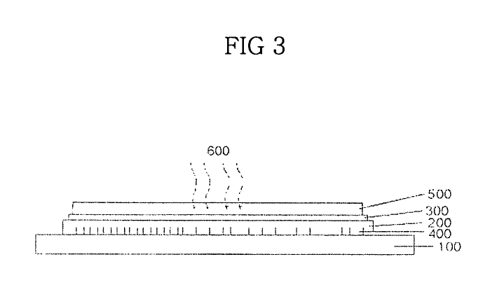

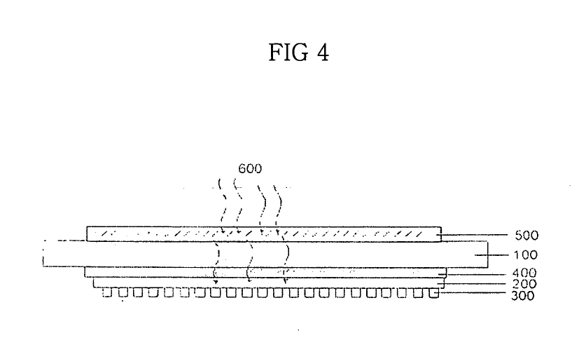

FIGS. 3 and 4 are sectional views of an organic conductive polymer X-ray image detector according to the position of the fluorescent layer 500. As shown in the drawings, the fluorescent layer 500 is disposed on the upper surface of the second electrode layer 300 or the lower surface of the substrate 100. The first electrode layer 400 is formed of a collection electrode of the active matrix TFT panel 150 collecting charges.

In the meantime, the first electrode layer 400 is formed between the substrate 100 and the organic conductive polymer layer 200, functions as an electron injector, and is made of a material such as ITO (indium tin oxide) which exhibits a high work function and is transparent.

The second electrode layer 300 is formed on the upper surface of the organic conductive polymer layer 200, functions as a hole injector, and is made of metal such as aluminum or indium, calcium, barium, and magnesium, exhibiting a lower work function, or an alloy thereof.

The organic conductive polymer layer 200 is an X-ray receptor generating electrons and holes by a radioactive ray. The organic conductive polymer layer 200 is preferably made of an organic polymer constituted by a polyparaphenylenevynilene derivative, a polytiophene derivative, a polyparaphenylene derivative, a polyethylene derivative, a polyacetyline derivative, and a polyfluorene derivative such as polyvynilcarbazole.

That is, the organic conductive polymer layer 200 is an organic polymer substance generating electrons and holes by an radioactive ray. The generated electrons and holes are collected by a collection electrode of TFT and detected as an electronic signal through TFT.

The organic conductive polymer layer 200 is a substitute substance for a-Se (anamorphic selenium) that is an inorganic X-ray receptor according to the conventional technology. The organic conductive polymer layer 200 is made of one or more conjugated polymer.

The organic conductive polymer layer 200 has different reaction characteristics according to the wavelength of light, that is, it most sensitively reacts mainly in a range of visible rays and less sensitively reacts in a range of an X-ray. Also, when the organic conductive polymer layer 200 has a single material, single layer structure, the absorption rate of the generated electron-hole pairs is low.

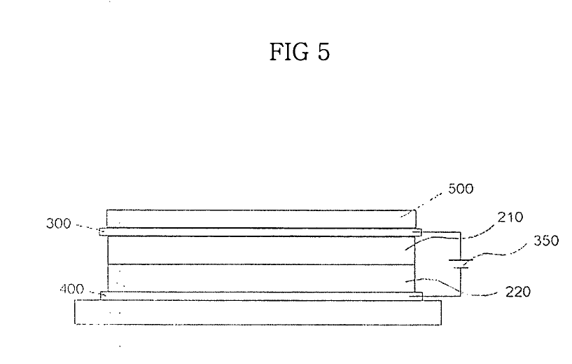

Thus, in the present invention, as shown in FIG. 5, the organic conductive polymer layer 200 is configured into a multiple of layers to increase a yield rate. That is, by forming C60 that is a material exhibiting a strong electron effinity, on a lower end of the second electrode as an electron acceptor, the electrons generated in the organic conductive polymer layer 200 are well transferred to the (+) pole. There is CN-PPV, C60 polymer, and perylene as the electron acceptor material exhibiting a strong electron effinity like C60.

In the meantime, the organic conductive polymer itself becomes a hole acceptor layer. Besides, the organic conductive polymer layer 200 can be configured as an X-ray receptor which has not a layered structure, by mixing a polymer material forming the electron acceptor layer and a polymer material forming a hole acceptor layer.

There is polyacetylene, polyisothianaphene, poly(paraphenylene), poly(phenylene vinylene) (“PPV”) as the type of typical conjugated polymer of the organic conductive polymer constituting the X-ray receptor.

PPV that is a typical material of an organic polymer constituting the organic conductive polymer layer has the following types according to an alkoxy derivative of PPV.

poly(2-methoxy-5-(2′-ethylhexyloxy)-1,4-phenylene vinylene)(“MEH-PPV”)

poly(2,5-dimethoxy-p-phenylene vinylene)(“PDMPV”)

poly(2,5-bis(c-holestanoxy)-1,4-phenylene vinylene)(“BCHA-PPV”)

polythiophene

poly(3-alkylthiophenes)(“P3AT”)

polycarbazone

poly(1,6-hep-tadiyne)

polyquinoline

polyanilines(“PANI”)

The organic conductive polymers used in the present invention can be dissolved in a solvent so that manufacturing of the X-ray receptor layer is made easy.

As a formation method of an organic polymer, there is a well-known spin-coating method by which a layer can be formed so that an X-ray receptor can be manufactured to have a uniform thickness.

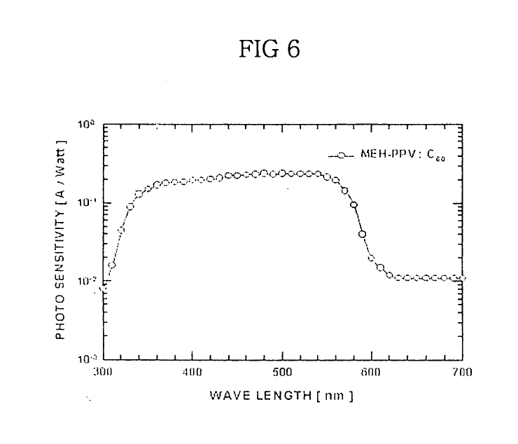

FIG. 6 is a graph showing the result of measurement of the photosensitivity per wavelength range of MEH-PPV:C60 that is an organic conductive polymer of the digital X-ray image detector according to the present invention.

As shown in FIG. 6, in reviewing the reaction characteristic of the organic conductive polymer layer 200, although the organic conductive polymer layer 200 generates electron-hole pairs by a radioactive ray like the amorphous selenium used as an X-ray receptor in the conventional digital radioactive detection apparatus, it generates more electron-hole pairs in a range of a visible ray.

Another characteristic feature of the present invention in which the organic conductive polymer layer 200 is used as a digital X-ray receptor is using a superior reaction characteristic of the range of a visible ray of the organic conductive polymer layer 200. In other words, a radioactive ray including image information is converted to a visible ray and the amount of electrical change of the X-ray receptor (the organic conductive polymer layer) is detected with respect to the visible ray so as to be manufactured by an X-ray image detector.

That is, since the reaction feature of the organic conductive polymer layer 200 is superior in the range of a visible ray, the fluorescent layer 500 generating a visible ray in reaction to a radioactive ray is formed on the upper surface or the lower surface of the organic conductive polymer layer 200 and the reaction of the organic conductive polymer layer 200 with respect to the visible ray generated from the fluorescent layer 500 is detected by a readout apparatus such as the active matrix TFT panel 150.

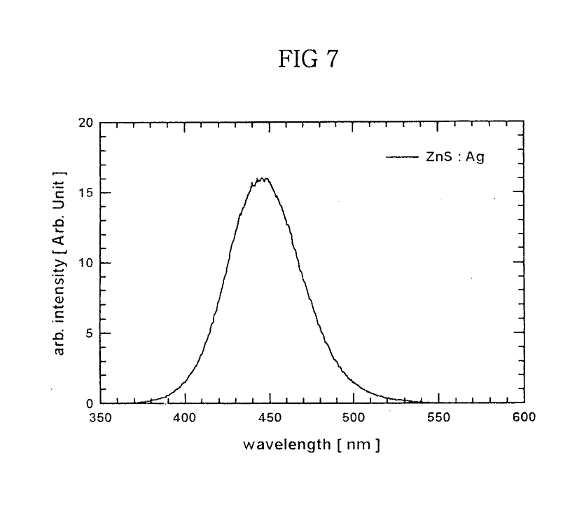

FIG. 7 shows a light emitting spectrum per wavelength of ZnS:Ag that is a typical material forming the fluorescent layer 500. Referring to FIG. 7, ZnS:Ag best diverges a visible ray in a blue area.

The fluorescent layer 500 preferably emits light having the same wavelength range as an absorption wavelength range or a reaction wavelength range of the organic conductive polymer layer 200. For the fluorescent layer 500, CaWO4 that is a main material of an intensifying screen of an X-ray film and Gd based and La based fluorescent materials that are rare-earth based are used.

In addition, CsI:Na, CsI:Tl ZnS:Ag,Cl ZnS:CuAl Y2O2S:Eu ZnS:Ag,Cl+CoO,Al2O3 Y2O2S:Eu+Fe2O3 Y2O3:Eu ZnS:Ag,Al Zn2SiO5:Mn Y2O2S:Tb materials are preferably used as the fluorescent layer formed on the second electrode layer.

The organic conductive polymer layer 200 is the organic conductive polymer layer 200 used as a material of a conventional light emitting body. The feature that a driving voltage of the organic conductive polymer layer 200 as a light emitting device is merely between several volts to tens of volts is well known. Thus, in the present invention utilizing a photosensitivity feature, the driving voltage is not different from the above which is merely between several volts to tens of volts.

In the conventional inorganic X-ray detector, since a voltage applied to electrodes at both ends to detect electron-hole pairs generated by Se that is an X-ray receptor is as high as 10 V/μm, assuming the thickness of the X-ray receptor is hundreds of μm, a high voltage of several kV DC must be applied.

Thus, the increase of thickness of the X-ray receptor to increase the radioactive ray detection feature requires excessively high voltage so that defects may exist in the receptor or the thickness is irregular, an electric field concentration occurs in a thin portion. As a result, the pixel of a circuit end is damaged or the detector panel itself is damaged which is a considerable hindrance in designing an X-ray detector.

In the present invention, since the driving voltage of the organic conductive polymer layer 200 is very lower than the inorganic X-ray receptor and a large area manufacturing is possible, the above hindrance is removed when designing the X-ray detector.

As described above, according to the present invention, since the organic conductive polymer layer is used as the X-ray receptor, the difficulty in manufacturing the X-ray receptor and the application of a high voltage which have been considerable problems in the process of manufacturing a conventional digital radioactive ray detection apparatus are solved.

Also, since the X-ray receptor layer used in the present invention is manufactured in a spin-coating method by dissolving organic conductive polymer, which is cheaper than inorganic materials such as a-Se, PbI2, HgI2, CdZnTe, TlBr, into an organic solvent, the thickness of the receptor can be manufactured to be uniform and a large area manufacturing is possible. Furthermore, since a flexible X-ray image detector can be manufactured, it can be applied to a detector having a curved surface like a CT.

Also, since the voltage applied to both ends of the X-ray receptor to detect an electric signal generated from the X-ray receptor layer can be maintained at a low level, the X-ray receptor and TFT device can be protected.

1. An X-ray image detector comprising:
an insulation substrate which is a physical support body;
a first electrode layer which is an electron collecting electrode formed on an upper surface of the substrate;
an organic conductive polymer layer formed on the upper surface of the first electrode layer and generating electron-hole pairs by a radioactive ray or a visible ray;
a second electrode layer formed on an upper surface of the organic conductive polymer layer;
a fluorescent layer disposed on an upper surface of the second electrode layer or a lower surface of the substrate; and
a readout apparatus connected to the first electrode layer on the substrate and detecting an electric image signal generated by the radioactive ray in the organic conductive polymer layer.

2. The X-ray image detector as claimed in claim 1, wherein the organic conductive polymer layer is polymer based consisting of a polyparaphenylenevynilene derivative, a polytiophene derivative, a polyparaphenylene derivative, a polyethylene derivative, a polyacetyline derivative, and a polyfluorene derivative such as polyvynilcarbazole.

3. The X-ray image detector as claimed in claim 1, wherein, to improve yield in detecting electron-hole pairs generated by absorbing photons generated from the fluorescent layer by an incident radioactive ray, the organic conductive polymer layer comprises:
an electron acceptor layer formed in contact with an electrode to which + pole is applied and made of C60, CN-PPV, and perylene which are materials exhibiting electron effinity; and
a hole acceptor layer adjacent to an electrode to which pole is applied and drawing holes,
wherein the electron acceptor layer and the hole acceptor layer are formed in the upper and lower portions of the organic conductive polymer layer, respectively.

4. The X-ray image detector as claimed in either claim 1, 2 or 3, wherein the fluorescent layer generates light of a visible ray area wavelength in reaction of an radioactive ray and made of CsI:Na, CsI:Tl or ZnS:Ag,Cl ZnS:Cu,Al Y2O2S:Eu ZnS:Ag,Cl+CoO,Al2O3 Y2O2S:Eu+Fe2O3 Y2O3:Eu ZnS:Ag,Al Zn2SiO5:Mn Y2O2S:Tb.

5. The X-ray image detector as claimed in claim 1, wherein the first electrode is made of ITO which provides electrons well, to which a negative electrode is applied.

6. The X-ray image detector as claimed in claim 1, wherein the second electrode is made of metal from a group consisting of Al, Ca, Mg, Au, Ba, and In which provide holes well and having low work functions, to which a positive electrode is applied.

7. The X-ray image detector as claimed in claim 1, wherein the readout apparatus is a TFT panel or a passive matrix panel.
